(19) United States
(12) Patent Application Publication
(10) Pub. No.: US 2019/0381806 A1
(43) Pub. Date: Dec. 19, 2019

(54) HYBRID HAND LABELER

(71) Applicant: AVERY DENNISON RETAIL INFORMATION SERVICES, LLC, Mentor, OH (US)

(72) Inventors: Jeanne Duckett, Franklin, OH (US); Frederick Pou, Centerville, OH (US); Timothy L. Brown, Dayton, OH (US); Jesus Romo, Fairborn, OH (US); Mark S. Morrow, Kettering, OH (US); Txus Carrion, Bayern (DE); Dee Sawyer, Spring Valley, OH (US); John Mistyurik, Troy, OH (US)

(21) Appl. No.: 16/444,637

(22) Filed: Jun. 18, 2019

Related U.S. Application Data
(60) Provisional application No. 62/686,430, filed on Jun. 18, 2018.

(51) Int. Cl. B41J 3/36; B41J 3/407; B41J 3/50; B65H 16/02; B65H 21/00; H02J 7/35

(52) U.S. Cl. CPC B41J 3/36; B41J 3/4075; H02J 7/355; B65H 16/02; B65H 21/00; B41J 3/50

(57) ABSTRACT

A portable hybrid hand labeler is disclosed that relies on mechanical motion, which eliminates the need for motors and the corresponding energy required to power the motors. The portable hybrid hand labeler also houses an ink jet head and a digital print mechanism, which offers the user infinite print flexibility. The portable hybrid hand labeler is preferably battery driven, and comprises a mechanism to harvest the kinetic energy from the trigger pull and a display panel with a solar panel to collect solar energy to trickle charge the battery pack, thereby increasing usage time between charges.

### CROSS REFERENCE TO RELATED APPLICATION(S)

The present application claims priority to and the benefit of United States provisional utility patent application No. 62/686,430 filed Jun. 18, 2018, which is incorporated herein by reference in its entirety.

### BACKGROUND

The present invention relates generally to a hybrid hand labeler that combines mechanical motion with digital printing. More particularly, the present disclosure relates to a battery/solar powered, portable hand labeler with downloadable print bands that provide the user with greater print variability and flexibility.

By way of background, mechanical hand labelers have been in the market for over 40 years, and can be somewhat efficient for the labeling of items, such as retail products, with data having limited variability. More specifically, the process of depressing molded indicia against an ink roller and then depressing it onto a label, paper or other media is a simple cost effective method of marking. Further, the ink used in this process has the added advantage of being sun resistant.

However, while traditional mechanical hand labelers can be cost effective, they also tend to have poor print quality, especially with respect to larger fonts. In fact, the relationship between the size of the font being printed by the mechanical hand labeler and the quality of the print is inversely proportional. Stated differently, the quality of the mechanical hand labeler print decreases as the size of the font increases. This inversely proportional relationship is attributable, in part, to the non-flexible print bands of the hand labeler. More specifically, the print bands of the mechanical hand labelers are molded prior to the assembly of the device. Therefore, the mechanical labeler print bands offer little if any print flexibility, whereas a digital print mechanism offers infinite print flexibility. Further, portable printers and/or hand labelers tend to be inefficient with respect to energy consumption, which limits the functionality and usage time between recharging. In addition, currently available portable printers depend on lithium ion battery technology. This design incorporates the potential for using alkaline or alkaline or NiCad batteries. Both of which are more commonly available to the average consumer and are easily transported.

Therefore, there exists in the art a long felt need for an improved, portable hand labeler that offers greater print flexibility and variability. There is also a long felt need in the art for a portable hand labeler that minimizes energy consumption and device downtime attributable to recharging of the device. The present invention discloses a hybrid hand labeler that relies on mechanical motion and digital printing using an ink jet head. The hybrid hand labeler also minimizes energy consumption by eliminating the need for motors, by harvesting kinetic energy from the otherwise required trigger/lever pulls, and by providing a solar panel on the display panel to collect solar energy that can be used to trickle charge the hand labeler's battery pack.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is a portable hybrid hand labeler comprised of an ink jet head and a digital print mechanism which offers infinite print flexibility to its user. More specifically, the hybrid hand labeler comprises downloadable print bands which enable simple device data input with print flexibility. The portable hybrid hand labeler further relies on mechanical motion with respect to paper/media/label movement, which eliminates the need for motors and the corresponding energy required to operate said motors. Further, the hybrid hand labeler comprises a mechanism to harvest the kinetic energy from the otherwise trigger/lever pull to trickle charge the labeler battery pack, thereby increasing usage time between charges and overall productivity of the hybrid hand labeler.

In another embodiment of the present invention, the hybrid hand labeler may also further comprise at least one solar panel positioned on or near the display panel. The solar panel enables the user to gather solar energy that, in turn, can be used to trickle charge the labeler battery pack, thereby prolonging the time between battery charges and increasing the efficiency of the hand labeler.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a front perspective view of the hybrid hand labeler in accordance with the disclosed architecture.

FIG. 2 illustrates a top perspective view of the hybrid hand labeler in accordance with the disclosed architecture.

FIG. 3 illustrates a perspective view of the right side of the hybrid hand labeler in accordance with the disclosed architecture.

FIG. 4 illustrates a perspective view of the left side of the hybrid hand labeler in accordance with the disclosed architecture.

FIG. 5 illustrates a back perspective view of the hybrid hand labeler in accordance with the disclosed architecture.

FIG. 6 illustrates a perspective view of the print head of the hybrid hand labeler in accordance with the disclosed architecture.

FIG. 7 illustrates a control board block diagram for the hybrid hand labeler in accordance with the disclosed architecture.

FIG. 8 illustrates a perspective view of the display panel and solar panel of the hybrid hand labeler in accordance with the disclosed architecture.

FIG. 9 illustrates a flowchart for the process of user input for the hybrid hand labeler in accordance with the disclosed architecture.

FIG. 10 illustrates a perspective view of the mechanical hand labeler band in accordance with the disclosed architecture.

FIG. 11 illustrates a flowchart for downloading digital bands technology (DBT) in accordance with the disclosed architecture.

FIG. 12 illustrates a flowchart for selecting digital bands in accordance with the disclosed architecture.

FIG. 13 illustrates a flowchart for the traceability process in accordance with the disclosed architecture.

FIG. 14 illustrates a perspective view of the hybrid hand labeler without its cover to show the gear mechanism in accordance with the disclosed architecture.

FIG. 15 illustrates a perspective view of the internal gear mechanism of the hybrid hand labeler in accordance with the disclosed architecture.

FIG. 16 illustrates a flowchart for printing a digital label of the present invention with a mechanical trigger pull.

FIG. 17 illustrates a flowchart of a price markdown process that may be accomplished using the hybrid hand labeler of the present invention in accordance with the disclosed architecture.

FIG. 18 illustrates one potential embodiment of a battery case for a plurality of batteries to power the hybrid hand labeler of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention discloses a portable hybrid hand labeler that comprises an ink jet head and a digital print mechanism which offers the user infinite print flexibility. Further, the portable hybrid hand labeler of the present invention relies on mechanical motion to advance the paper/media, which eliminates the need for motors and the corresponding energy required to run the motors. The hybrid hand labeler also preferably comprises a mechanism to harvest the kinetic energy from the otherwise required trigger/lever pull and a display panel with a solar panel to collect solar energy that can, in turn, be used to trickle charge the battery pack, thereby increasing usage time between charges and improving overall productivity.

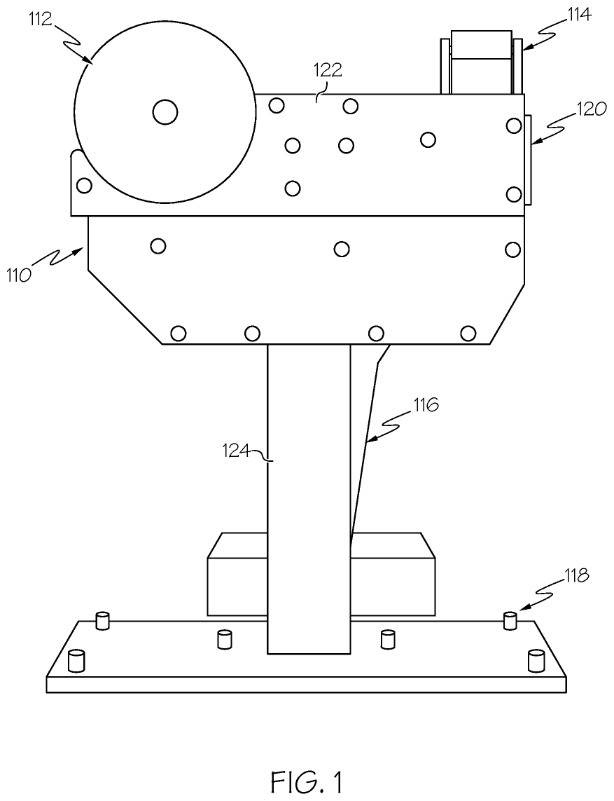

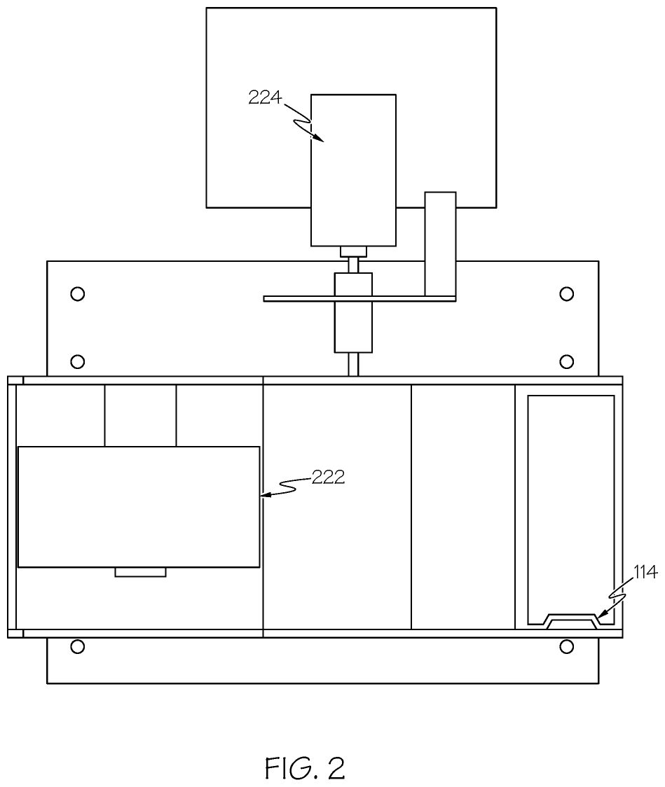

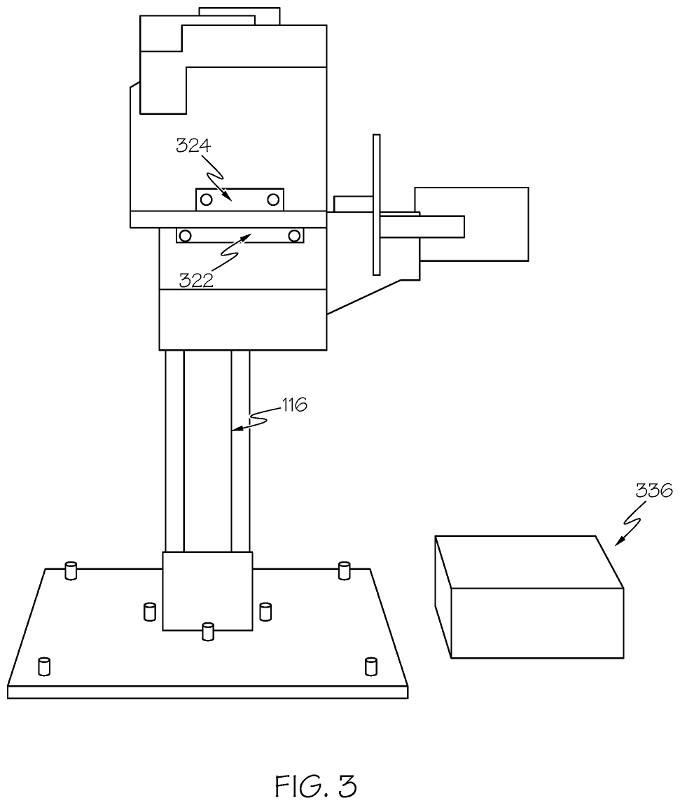

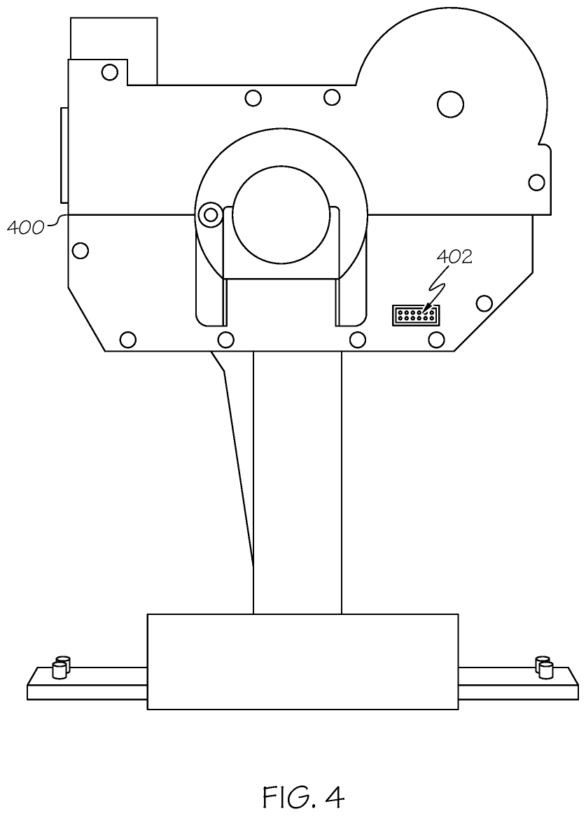

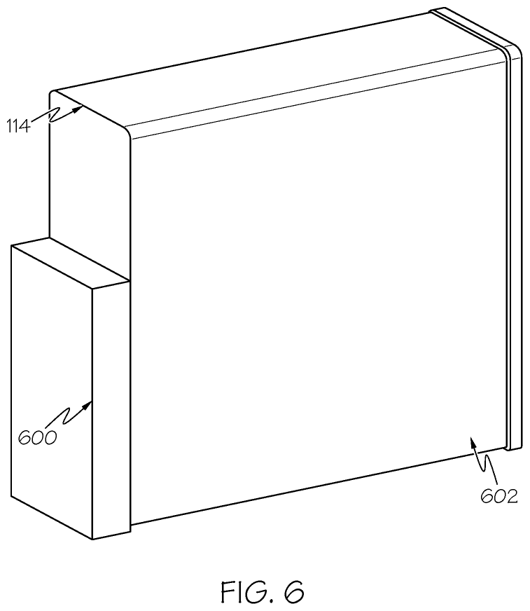

Referring initially to the drawings, FIGS. 1-6 illustrate several views of the advanced or hybrid hand labeler 110 of the present invention, which comprises a housing 120, a supply roll holder 112 and an ink jet head 114. The housing 120 may be molded of a lightweight, durable plastics material, or any other suitable material as is known in the art, and also includes a handle portion 124. Further, an actuator or mechanical trigger or lever 116 is positioned along handle portion 124 for user convenience, the operation of which is described more fully below.

The hybrid hand labeler 110 is adapted to receive a supply of pressure sensitive labels or other media 222, such as the kind manufactured and sold by Avery Dennison Corporation of Pasadena, Calif., which can be housed on the supply roll holder 112 until needed. More specifically, the supply roll of media 222 is housed on supply roll holder 112, and is advanced on demand through a feed path via a roller and across a printing surface 120 to receive a desired text or graphic when the lever 116 is released.

When the lever 116 is depressed and released, the ink jet head 114 begins printing the desired image on a portion of media 222 while it is positioned on the printing surface 120. More specifically, the pressure sensitive media 222 moves past the ink jet head 114 and is directed across the printing surface 120 where it is successfully printed upon. Each pressure sensitive label is printed on the printing surface 120 by movement of the media 222 and the energy of ink jet head 114 in response to activation of the lever 116 and a gear drive (as explained more fully below), and the web of pressure sensitive material is advanced by a predetermined increment when the lever 116 is released. Said predetermined increment can be adjusted to suit a particular user's needs and/or to match the spacing of the labels on the carrier web. The resulting printed label is then peeled from the carrier web when the carrier web is reversed, and directed downwardly and rearwardly through the hand labeler 110. Once peeled and detached from the carrier web, the label is positioned against the serrated edge 324 of hybrid hand labeler 110, and allows the label with the printed image thereon to be applied to an article, such as a retail product or other item (not shown).

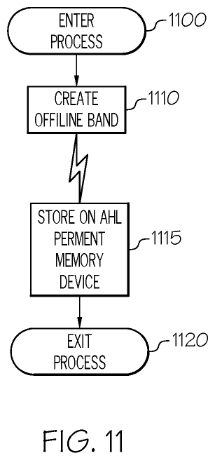

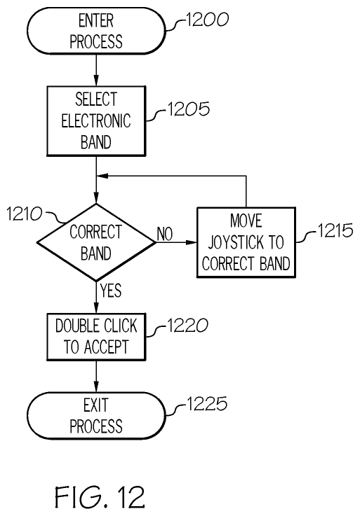

The ink jet head 114 further comprises a digital print mechanism dot line 600, which offers infinite print flexibility and versatility. More specifically, the digital print mechanism dot line 600 comprises a plurality of downloadable print bands (images) that can be printed with ink jet head 114, which enabled with simple device data input provides increased print flexibility. The process for downloading and selecting the print bands to be printed with ink jet head 114 (or dot line 600) is further described below and illustrated in FIGS. 11 and 12. Inkjet head 114 contains an ink reservoir 602. Additionally, the hybrid hand labeler 110 may comprise a drip pan 322 with a sponge or other absorbent material contained therein for catching surplus ink from purging cycles or other print functions of the hybrid hand labeler 110.

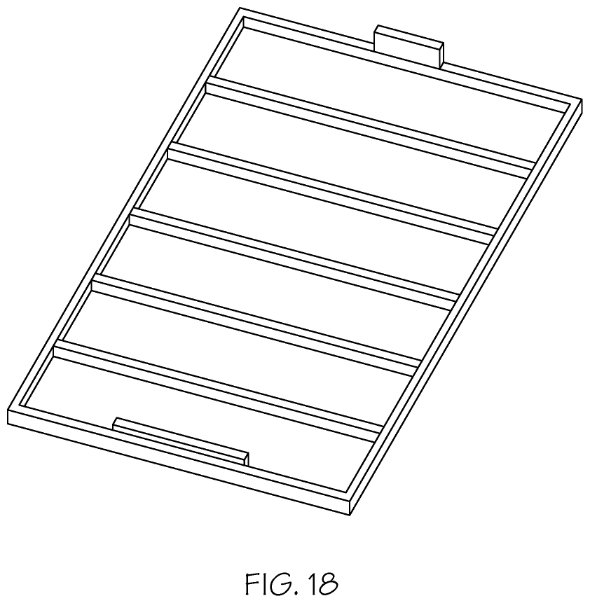

Furthermore, as illustrated in FIGS. 1, 3 and 5, a plate 118 may be provided as a stand for the hybrid hand labeler 110 when the device is not in use and/or is being charged. Further, as the hybrid hand labeler 110 may be used as a handheld device, the hybrid hand labeler 110 may be charged via a charging station (not shown) or, in another embodiment, may utilize replaceable batteries (not shown) contained in a holder 1800, such as the one shown FIG. 18. More specifically, the hybrid hand labeler 110 may be plugged into the charging station via an electrical outlet 402, and supported by the plate 118 while being charged.

In another embodiment of the present invention, the hybrid hand labeler 110 may further comprise a motor 224, such as a DC motor, as an alternate method of moving the supply web of labels or media 222 in lieu of, or in addition to, using the mechanical lever 116. The DC motor 224 may be controlled and powered via a control box 336, and is preferably encased in a housing 400 for its protection.

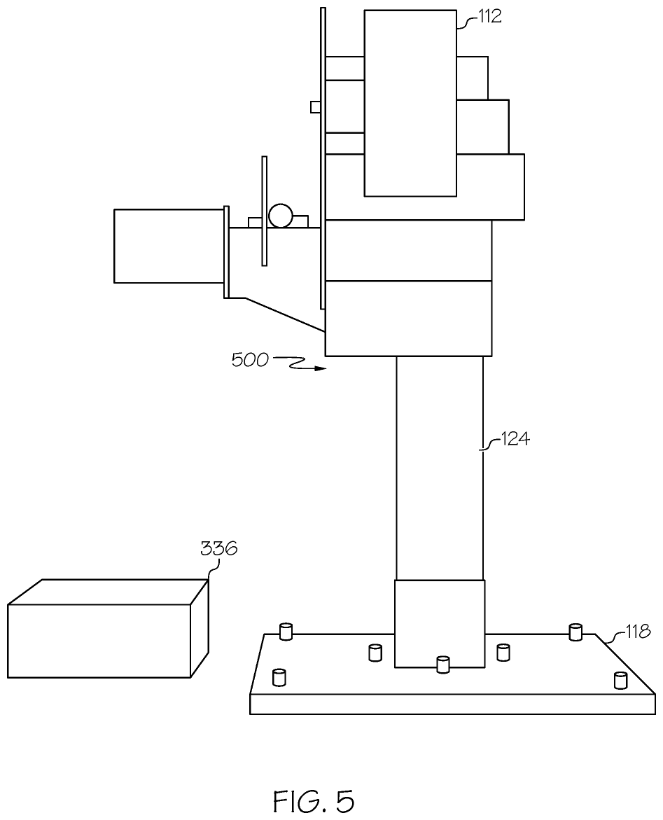

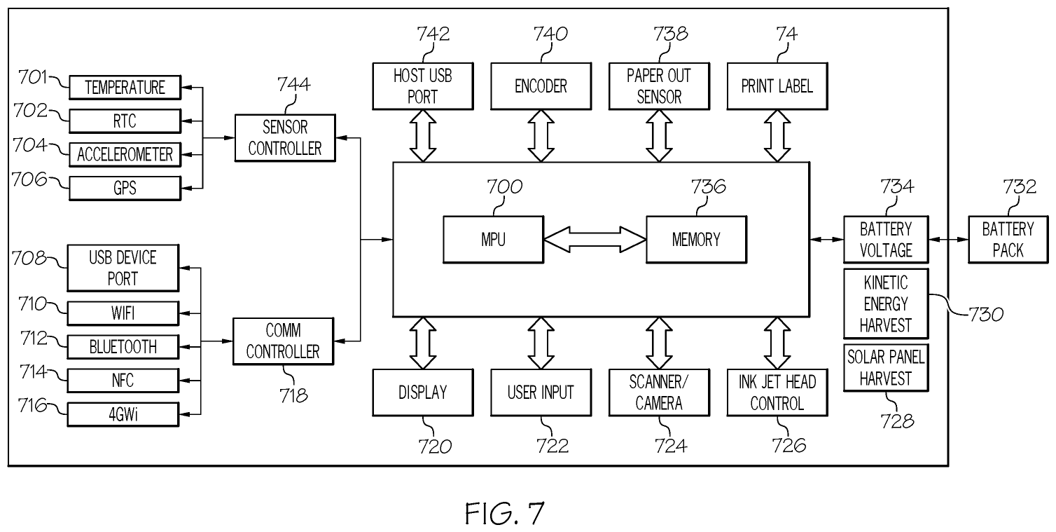

Furthermore, as shown in FIG. 5, the hybrid hand labeler 110 may further incorporate a switch mechanism 500 in order to engage the trigger/lever 116 or engage the motor 224. The switch mechanism may be a lock/unlock switch, or any other switch commonly known in the art. If the trigger/lever 116 is engaged, kinetic energy is harvested from the activation of the trigger/mechanical lever 116 which can be used to trickle charge the battery pack 732 of FIG. 7. This use of the kinetic energy generated by the activation of lever 116 increases the overall usage time of the labeler 110 between charges and increases overall productivity.

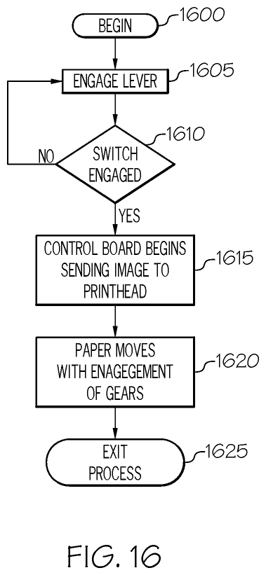

FIG. 16 illustrates a flowchart for initiating the printing of a digital label with a pull of mechanical trigger 116. More specifically, the process is entered at step 1600, and the lever 116 is engaged at step 1605. At step 1610, a determination is made as to whether the switch is engaged. If the enable switch is not engaged in step 1610, the process returns to 1605 to wait for another pull of trigger 116. If, on the other hand, the enable switch 500 is engaged at step 1610, the process proceeds to step 1615, wherein the control board 700 sends the appropriate data and power to printhead 114 to initiate the printing process. In step 1620, the loaded paper supply is then moved forward with the gear engagement, and the process exits at step 1625.

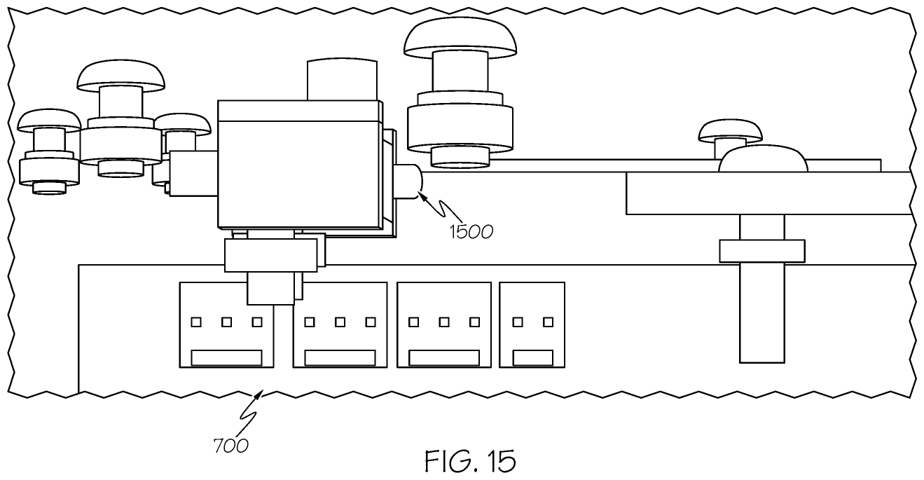

Generally, normal print function occurs when the mechanical lever 116 is fully depressed and released. More specifically, lever 116 is in communication with switch 1500 (shown in FIG. 15), which is, in turn, connected to control board 700 (shown in FIG. 7). Engaging the switch 1500 signals the hand labeler processor to begin the print process. The control board 700 is disclosed in FIG. 7, wherein the various components of the control board 700 are identified. More specifically, the control board 700 comprises a sensor controller 744 which has temperature 701, RTC (real time clock) 702, accelerometer 704, and GPS (global positioning system) 706 capabilities. Also, the control board 700 comprises the communication controller 718, which has a USB device port 708 and WiFi 710, Bluetooth 712, NFC (near field communication) 714, and 4GWi 716 capabilities.

As illustrated in FIG. 7, the sensor controller 744 and the communication controller 718 both communicate with the MPU 700 and memory 736, which communicate with the battery voltage 734, a kinetic energy harvester 730, a solar panel harvester 728, and battery pack 732. Other components that are capable of communicating with MPU 700 and memory 736 include, but are not limited to, a host USB port 742, an encoder 740, a paper out sensor 738, a print label 74, display 720, a user input 722, a scanner/camera 724, and an ink jet head control 726.

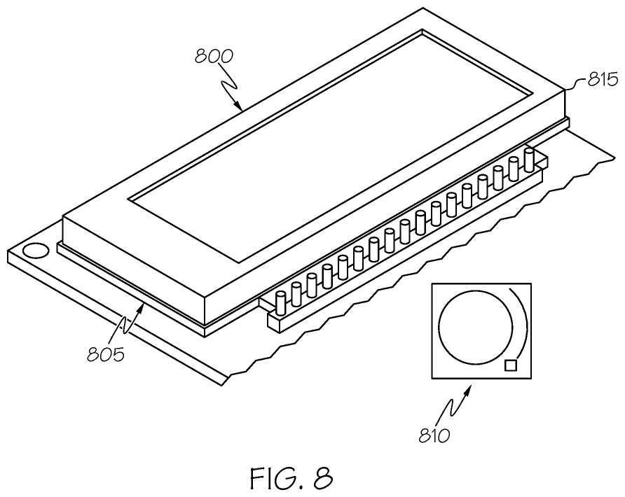

As best shown in FIG. 8, hybrid hand labeler 110 also comprises a display panel 800 that, in one embodiment presently contemplated, can contain at least one solar panel 810 and a housing 805 that protects the display panel 815 and solar panel 810 if, for example, hand labeler 110 is dropped or comes into contact with another object. Solar energy may be collected from the display panel 800 via the solar panel 810, and can be used in turn to provide a charge, such as a trickle charge, to the battery pack to prolong the time between battery charges and increase overall productivity of the hybrid hand labeler 110.

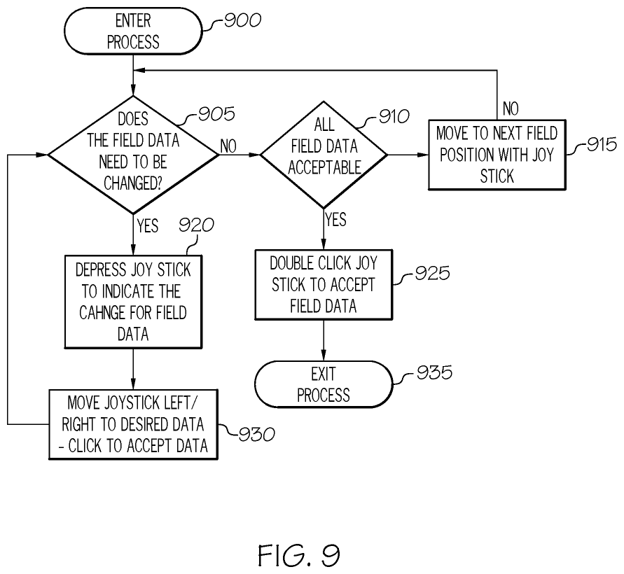

FIG. 9 discloses a schematic of the user input process. A user enters the process at step 900, and determines if the field data needs to be revised at step 905. If the field data needs to be revised, then the user can use a joy stick (or other mechanism known in the art for making a selection) to indicate the change to the field data at step 920. Then, at step 930, a user moves the joystick to make a desired data choice, then clicks to accept said choice and returns to step 905. If, on the other hand, the field data does not need to be revised or if the revision has already been accomplished via steps 920 and 930, then the existing field data is accepted at step 910. If the field data is accepted at step 910, a user can move to the next field position with the joy stick to start the process over at step 915, or the user can double click the joy stick (or other mechanical device used for indicating a selection) to accept all of the field data at step 925. The user then exits the user input process at step 935.

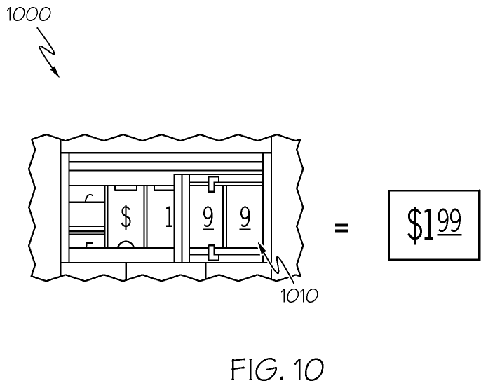

FIG. 10 discloses the one possible embodiment of a printer band 1000 that may be used in connection with the hybrid hand labeler 110. More specifically, the printer band 1000 may disclose the various characters and font sizes 1010 displayed, for example, for a pre-set price. As stated supra, the ink jet head 114 comprises a digital print mechanism in the form of a dot line 600, which offers infinite print flexibility. More specifically, the digital print mechanism dot line 600 comprises a plurality of downloadable printer bands 1000, which enable simple device data input with greater print flexibility.

As disclosed in FIG. 11, a user can also download the Digital Bands Technology (DBT) to the hybrid hand labeler device 110. More specifically, a user enters the process at step 1100. At step 1110, the user creates, for example, an offline printer band. At step 1115, the offline printer band is stored on the hybrid hand labeler's permanent memory device, and the user exits the process at step 1120.

FIG. 12 discloses one possible process for selecting digital bands 1000. More specifically, the user enters the band selection process at step 1200. At step 1205, the user selects an electronic band 1000, and, at step 1210, determines if the selected band is the correct band. If the selected band is not the correct band, the user moves the joystick (or other device for making a selection) to the correct band at step 1215 and returns to step 1210 for verification of the selection. If, on the other hand, the selected band is the correct band, at step 1220, the user double clicks (or some other appropriate action to indicate approval) to accept the selected band. The user then exits the band selection process at step 1225.

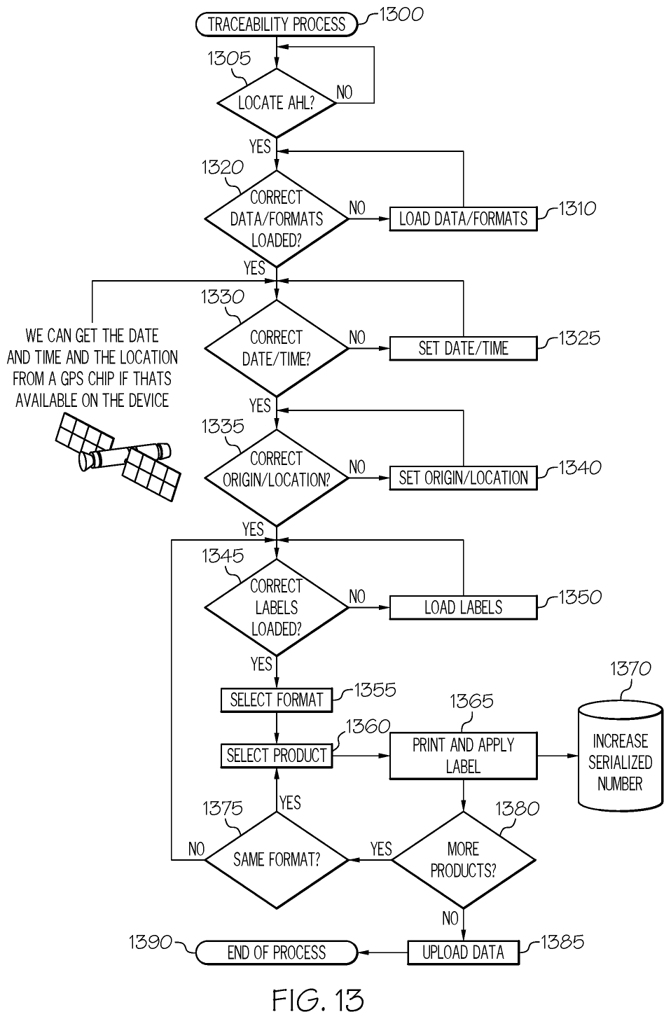

The hybrid hand labeler is also capable of producing labels for use in traceability processes, such as food traceability processes that are used to improve food safety and reduce food waste. For example, it has been reported that Americans alone waste as much as 150,000 tons of food each day, and that, annually, the amount of wasted food has grown on the equivalent of over 30 million acres of cropland, or approximately 7.5% of all harvested cropland in the United States. FIG. 13 discloses an example of one possible traceability process that can be performed in conjunction with the hybrid hand labeler of the present invention. More specifically, the user enters the traceability process at step 1300. At step 1305, it is determined if the hybrid hand labeler 110 can be located, for example, via GPS or other known means in the art for locating a device. If the hybrid hand labeler 110 cannot be located, the process returns to step 1300 to begin again. If, on the other hand, the labeler is located, the process continues to step 1320 where it is determined if the correct data and formats are loaded on the device. If the correct data and formats are not loaded, the process proceeds to step 1310, and the correct data and formats are loaded and the process proceeds to step 1320 for verification.

If the correct data and formats are loaded, the process continues to step 1330, wherein it is determined if the correct date and time are loaded. If the correct date and time are not loaded, the process proceeds to step 1325 and the correct date and time are loaded and the process proceeds to step 1330 for verification. Alternatively, if the labeler is equipped with a GPS (global positioning system) chip, the correct date, time and location of the labeler may be determined via the same. If the correct date and time are loaded, the process continues to step 1335, wherein it is determined if the correct origin or location is loaded. If the correct origin and/or location are not loaded, the process proceeds to step 1340, and the origin and location are loaded. If the correct origin and location are loaded, the process continues to step 1340, wherein it is determined if the correct labels are loaded. If the correct labels are not loaded, the process goes to step 1350 and the correct labels are loaded at step 1345. Once the correct labels are loaded, the process continues to step 1355, wherein the format is selected.

At step 1360, the product is selected and, at step 1365, the user prints and applies the label to the product and increases the serialized number at step 1370. At step 1380, it is determined if more labels are needed for additional products. If more labels are needed for products, the process proceeds to step 1375 to determine if the same label format applies for the next product. If the same format applies, the process returns to step 1360 and proceeds accordingly. If, on the other hand, a different label format is required (e.g., for a different product or any other user selected reason), the process returns to step 1350 to load the appropriate label and the process proceeds accordingly. If no additional products are needed at step 1380, the process continues to step 1385 where the data is uploaded and the process terminates at 1390.

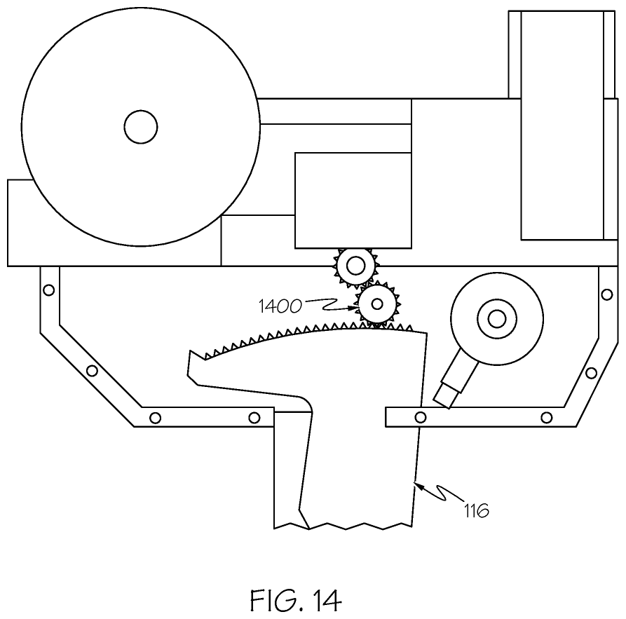

FIG. 14 discloses the hybrid hand labeler 110 with a portion of the housing removed to expose the interaction of the gear drive 1400 and the mechanical lever 116. Further, FIG. 15 discloses switch 1500 which is connected to control board 700 (see FIG. 7). Normal printing occurs after the mechanical lever 116 is fully depressed such that it connects with switch 1500, which, in turn, communicates with control board 700 to print the selected image on the label and then lever 116 is released.

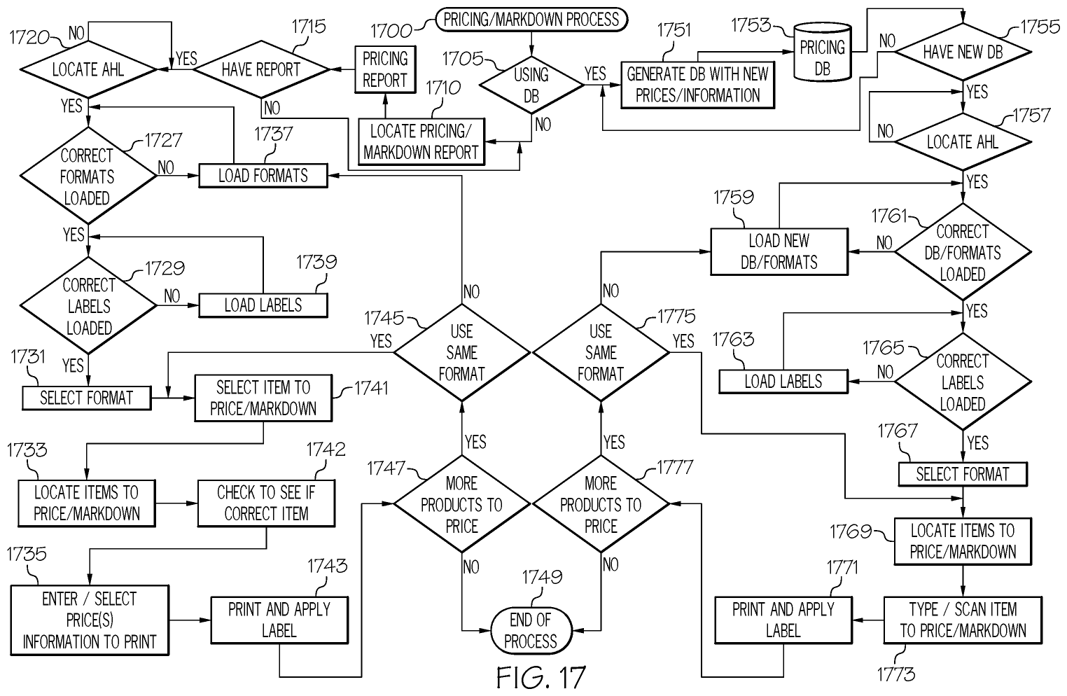

FIG. 17 discloses an example of a pricing/markdown process that can be accomplished with the hybrid hand labeler 110 of the present invention. More specifically, a user enters the process at step 1700, and indicates whether he/she will be using a database to accomplish the pricing/markdown function at step 1705. If no database is identified or selected at step 1705, the user attempts to locate the pricing/markdown report in step 1710. At 1715, a determination is made as to whether such report exists or can be found. If the report cannot be found, the process returns to step 1710. If, on the other hand, the report is located, the process proceeds to step 1720 to locate the hybrid hand labeler.

Once hybrid hand labeler 110 is located, the user verifies that the correct label formats are loaded in step 1727. If the correct label formats are not loaded, they are loaded at step 1737, and the process proceeds back to step 1727 for verification. Once the correct label formats are loaded, the process proceeds to step 1729 to determine if the correct labels are loaded onto hybrid hand labeler 110. If the correct labels are not loaded, they are loaded at step 1739, and the process proceeds back to step 1729 for verification. Once the correct labels are loaded, the process proceeds to step 1731 where the user selects the format. If a format change is required, at step 1745, the user may return to step 1737 to accomplish the same. If no format change is necessary, the user selects the item for pricing adjustment at step 1741.

Next, the products selected for price adjustment are located at step 1733, and verified at step 1742. Once the products have been selected and verified, the user enters the new pricing (or selects the same from a list of available pricing) at step 1735. The user then prints the label by pulling lever 116 on hybrid hand labeler 110, and applies the label onto the selected product at step 1743. At step 1747, the user determines if more products need to be labeled. If more products require labelling, at step 1745, the user determines if the same format is to be used. If the same format is to be used, the process returns to step 1741. If, on the other hand, different formatting is required, the process returns to step 1737 where correct formats may be loaded. Once all products have been appropriately labelled, the user may exit the process at step 1749.

Returning to step 1705, if a database is to be used as part of the process, a database report is generated in step 1751 with new pricing and/or other relevant information. Following data processing at step 1753, a determination is made at step 1755 whether the new database is acceptable. If the new database is not acceptable, the process returns to step 1751 and the process is repeated. If, on the other hand, the new database is acceptable, the process proceeds to step 1757 in which the hybrid hand labeler 110 is located.

Once hybrid hand labeler 110 is located, the user verifies that the correct database and/or label formats are loaded in step 1761. If the correct database and/or label formats are not loaded, they are loaded at step 1759, and the process proceeds back to step 1761 for verification. Once the correct database and/or label formats are loaded, the process proceeds to step 1765 to determine if the correct labels are loaded onto hybrid hand labeler 110. If the correct labels are not loaded, they are loaded at step 1763, and the process proceeds back to step 1765 for verification. Once the correct labels are loaded, the process proceeds to step 1767 where the user selects the format. If a format change is required, at step 1775, the user may return to step 1759 to accomplish the same. If no format change is necessary, the user selects the item for pricing adjustment and locates the same at step 1769.

Once the products have been selected and verified, the user enters or scans the new pricing (or selects the same from a list of available pricing) at step 1773. The user then prints the label by pulling lever 116 on hybrid hand labeler 110, and applies the label onto the selected product at step 1771. At step 1777, the user determines if more products need to be labeled. If more products require labelling, at step 1775, the user determines if the same format is to be used. If the same format is to be used, the process returns to step 1769. If, on the other hand, different formatting is required, the process returns to step 1759 where correct formats may be loaded. Once all products have been appropriately labelled, the user may exit the process at step 1749.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hybrid hand labeler comprising:
a housing;
a handle portion comprising a lever;
a supply roll holder for supplying a media;
a roller;
an ink jet head; and
a printing surface.

2. The hybrid hand labeler of claim 1, wherein activating the lever causes the roller to feed the media across the printing surface where it is printed upon by the ink jet head.

3. The hybrid hand labeler of claim 1 further comprising a battery, wherein activating the lever causes a charge to be sent to the battery.

4. The hybrid hand labeler of claim 3 further comprising a solar panel for charging said battery.

5. The hybrid hand labeler of claim 1, wherein the ink jet head comprises a digital print mechanism having downloadable print bands.

6. The hybrid hand labeler of claim 1 further comprising a drip pan, and a plate for housing the hybrid hand labeler when not in use.

7. The hybrid hand labeler of claim 1 further comprising a motor and a control box.

8. The hybrid hand labeler of claim 1 further comprising a display panel.

9. The hybrid hand labeler of claim 1 further comprising a serrated edge for cutting the media.

10. A method of utilizing a hybrid hand labeler having an ink jet head comprising the following steps:
providing a hybrid hand labeler having a housing, a lever, a printing surface and a supply roll of media;
feeding the supply roll of media across the printing surface to receive printing from the ink jet head;
activating the lever; and
printing an image on a portion of the supply roll of media.

11. The method of claim 10 further comprising a battery that receives a charge when the lever is activated.

12. The method of claim 10 further comprising the step of:
charging a battery with a solar panel attached to the hybrid hand labeler.

13. The method of claim 10 further comprising the step of :
positioning the printed image against a serrated edge of the hybrid hand labeler.

14. The method of claim 13 further comprising the step of:
detaching the printed image from the supply roll of media.

15. The method of claim 14 further comprising the step of:
applying the printed image to an article.

16. A portable hybrid hand labeler comprising:
a handle portion and a lever;
a supply of a media;
an ink jet head; and
a battery, wherein activation of the lever (i) causes the ink jet head to print on the media and (ii) send a charge to the battery.

17. The hybrid hand labeler of claim 16 further comprising a display panel with at least one solar panel capable of providing a charge to the battery.

18. The hybrid hand labeler of claim 16, wherein the ink jet head further comprises a digital print mechanism having a plurality of print bands.

19. The hybrid hand labeler of claim 16 further comprising a motor and a control box.

20. The hybrid hand labeler of claim 16 further comprising a drip pan and a serrated edge.
